(19) United States
(12) Patent Application Publication
(10) Pub. No.: US 2026/0115091 A1
(43) Pub. Date: Apr. 30, 2026

(54) ENERGIZING STRUCTURE FOR COLD AND HOT MASSAGE HEAD OF MASSAGE GUN

(71) Applicant: Zhejiang Red And Black Technology Co., Ltd., Lishui (CN)

(72) Inventors: Xinyi Shu, Jinyun County (CN); Lifeng Shu, Jinyun County (CN)

(21) Appl. No.: 18/961,250

(22) Filed: Nov. 26, 2024

(30) Foreign Application Priority Data
Oct. 30, 2024 (CN) 2024226421805

(51) Int. Cl. A61H 23/00; A61H 23/02

(52) U.S. Cl. CPC A61H 23/006; A61H 23/0254; A61H 2201/0207; A61H 2201/0214

(57) ABSTRACT

An energizing structure for a cold and hot massage head of a massage gun, including a fixed seat, a bushing, a conductive elastic piece, a slide bar, and a fixing base of a massage head. A connection portion protrudes from the fixing base of the massage head, and is embedded in the bushing. The fixed seat is fixedly disposed on the connection portion. A through-hole is provided at a bottom of the bushing. A limit groove is further provided at the bottom of the bushing, and is connected to the through-hole. A conductive wire protrudes from an edge of the fixed seat. The conductive elastic piece is bent, and has one side abutting against the conductive wire and an inner wall of the bushing and the other bent side passing through the through-hole and disposed in the limit groove. The bushing is fixedly disposed in the slide bar.

### TECHNICAL FIELD

The present disclosure relates to the field of massage guns, and in particular to an energizing structure for a cold and hot massage head of a massage gun.

### BACKGROUND

A massage gun, as a piece of portable massage equipment, has attracted extensive attention on the market in recent years. The massage gun deeply massages human muscles via a massage head using the principle of high-frequency vibration, to achieve the effect of relaxing muscles and relieving pain. With the development of technologies, massage guns with cold and hot massage functions are emerging in markets. This massage gun provides users with comfortable and efficient massage experience by adjusting a temperature of the massage head.

However, in the conventional technology, internal conductive components in the massage gun with cold and hot massage functions may have poor contact problem due to the complex vibration environment generated during working. This causes malfunction, affecting user experience. In addition, the massage gun is screwed inward at a specific angle to establish an electrical connection between the massage head and the PCB, which is not flexible.

### SUMMARY

In view of this, it is necessary to provide an energizing structure for a cold and hot massage head of a massage gun, including a fixed seat, a bushing, a conductive elastic piece, a slide bar, and a fixing base of a massage head, where a connection portion protrudes from the fixing base of the massage head, the connection portion is embedded in the bushing, the fixed seat is fixedly disposed on the connection portion, a through-hole is provided at a bottom of the bushing, a limit groove is further provided at the bottom of the bushing, the limit groove is connected to the through-hole, a conductive wire protrudes from an edge of the fixed seat, the conductive elastic piece is bent, the conductive elastic piece has one side abutting against the conductive wire and an inner wall of the bushing and the other bent side passing through the through-hole and disposed in the limit groove, and the bushing is fixedly disposed in the slidebar.

Preferably, the bushing is connected to the slide bar via glue.

Preferably, a wire passing hole is provided on the slide bar, and the wire passing hole is opposite to the through-hole.

Preferably, a placement groove is further provided at a middle part of the bottom of the bushing, an edge of the placement groove extends outwardly to form a connection groove, and the connection groove is connected to the limit groove.

Preferably, a retention groove is provided on the fixed seat, a printed circuit board (PCB) is disposed in the retention groove, and the PCB is electrically connected to the conductive wire.

Preferably, a wiring terminal is fixedly disposed on the PCB.

Preferably, an end surface of the connection portion is locked with the fixed seat in a threaded manner.

Preferably, a silicone washer is sleeved on the fixing base of the massage head.

### BRIEF DESCRIPTION OF THE DRAWINGS

FIG. 1 is a schematic diagram of a structure of an energizing structure for a cold and hot massage head of a massage gun according to an embodiment of the present disclosure;

FIG. 2 is an exploded view of an energizing structure for a cold and hot massage head of a massage gun according to an embodiment of the present disclosure;

FIG. 3 is a schematic diagram of a structure that a fixed seat is disposed on a bushing according to an embodiment of the present disclosure;

FIG. 4 is a schematic diagram of a structure of a bushing according to an embodiment of the present disclosure;

FIG. 5 is a schematic diagram of a structure of a fixed seat according to an embodiment of the present disclosure; and

FIG. 6 is a profile of an energizing structure for a cold and hot massage head of a massage gun according to an embodiment of the present disclosure.

Reference numerals:

1: fixed seat; 11: conductive wire; 12: retention groove; 2: bushing; 21: through-hole; 22: limit groove; 23: placement groove; 24: connection groove; 3: conductive elastic piece; 4: slide bar; 41: wire passing hole; 5: PCB; 51: wiring terminal; 6: fixing base of massage head; 61: connection portion; 7: silicone washer.

### DETAILED DESCRIPTION OF THE EMBODIMENTS

To make the objectives, technical solutions and the advantages of the present disclosure clearer, an energizing structure for a cold and hot massage head of a massage gun provided in the present disclosure is described in further detail below with reference to the drawings and embodiments. Understandably, the described embodiments are merely intended to explain the present disclosure, rather than to limit the present disclosure.

It should be understood that in the description of the present disclosure, unless otherwise specified, “a plurality of” means two or more; and terms such as “central”, “longitudinal”, “transverse”, “upper”, “lower”, “left”, “right”, “inside”, “outside”, “front”, “rear”, “head”, “tail”, “vertical”, “horizontal”, “top”, and “bottom” indicate the orientation or position relationships based on the drawings. They are merely intended to facilitate and simplify the description of the present disclosure, rather than to indicate or imply that the mentioned device or components must have a specific orientation or must be constructed and operated in a specific orientation. Therefore, these terms should not be construed as a limitation to the present disclosure. Moreover, the terms “first”, “second”, and “third” are merely used for description, and are not intended to indicate or imply relative importance.

In the description of the present disclosure, it should be noted that, unless otherwise clearly specified, meanings of terms “install”, “connected with”, and “connected to” should be understood in a board sense. For example, the connection may be a fixed connection, a removable connection, or an integral connection; may be a mechanical connection or an electrical connection; may be a direct connection or an indirect connection by using an intermediate medium; or may be intercommunication between two components. Those of ordinary skill in the art may understand specific meanings of the above terms in the present disclosure based on a specific situation.

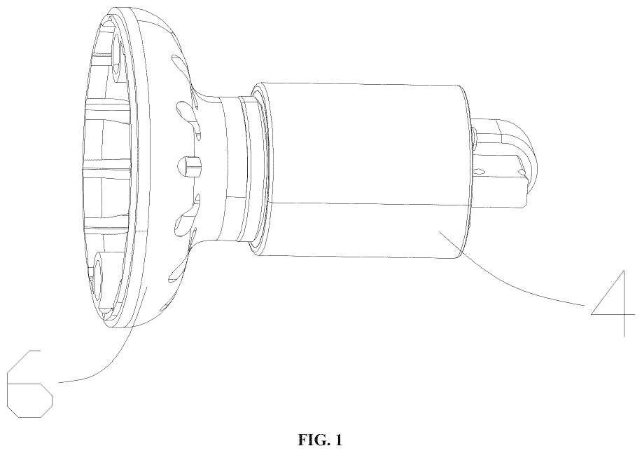

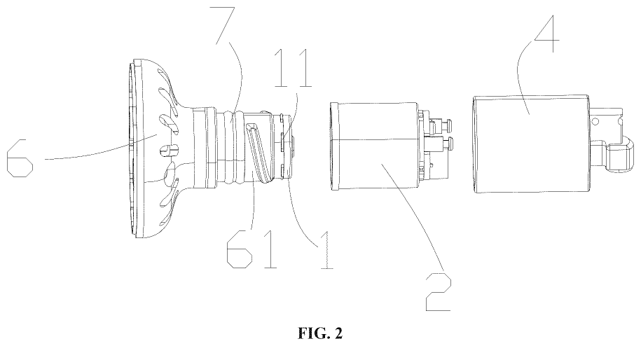

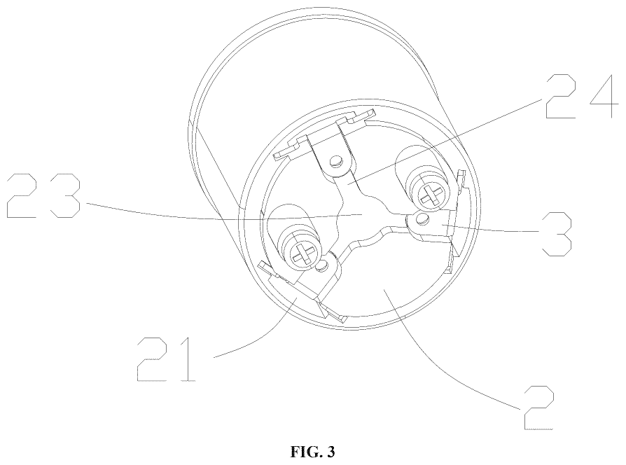

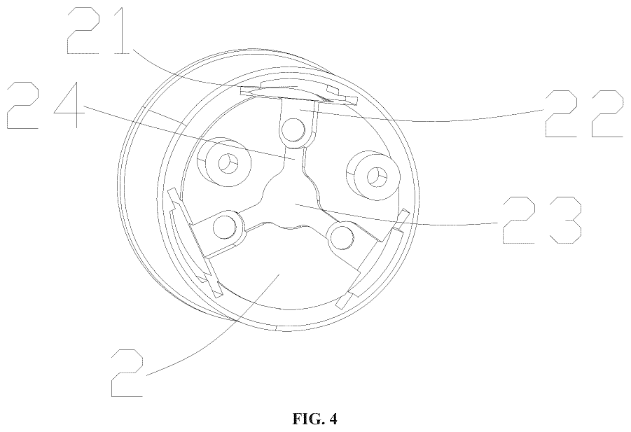

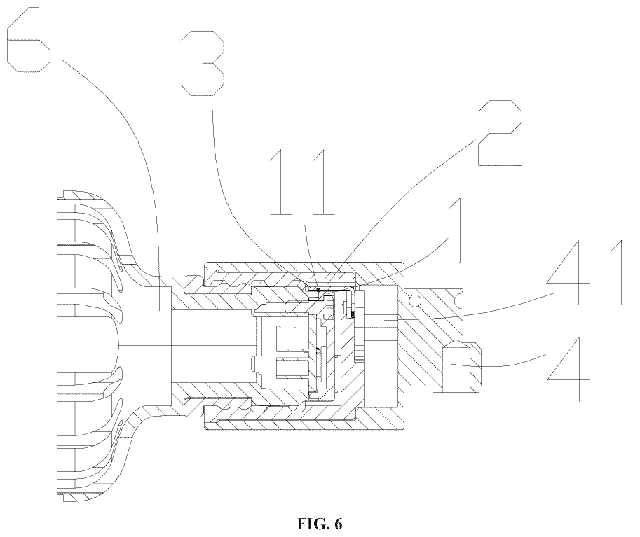

Referring to FIG. 1 to FIG. 6, embodiments of the present disclosure provide an energizing structure for a cold and hot massage head of a massage gun. The energizing structure for a cold and hot massage head of a massage gun includes a fixed seat 1, a bushing 2, a conductive elastic piece 3, a slide bar 4, and a fixing base of a massage head 6. A connection portion 61 protrudes from the fixing base of the massage head 6, and the connection portion 61 is embedded in the bushing 2. The fixed seat 1 is fixedly disposed on the connection portion 61. A through-hole 21 is provided at a bottom of the bushing 2. A limit groove 22 is further provided at the bottom of the bushing 2, and the limit groove 22 is connected to the through-hole 21. A conductive wire 11 protrudes from an edge of the fixed seat 1. The conductive elastic piece 3 is bent, and the conductive elastic piece 3 has one side abutting against the conductive wire 11 and an inner wall of the bushing 2 and the other bent side passing through the through-hole 21 and disposed in the limit groove 22. The bushing 2 is fixedly disposed in the slide bar 4.

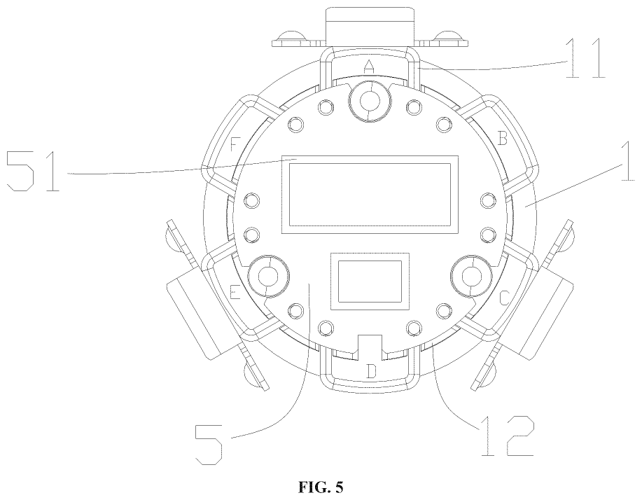

In this embodiment, the energizing structure for a cold and hot massage head of a massage gun includes the fixed seat 1, the bushing 2, the conductive elastic piece 3, the slide bar 4, and the fixing base of the massage head 6. The fixed seat is locked on an end surface of the connection portion 61 of the fixing base of the massage head 6 via a thread, a double thread is provided on a side surface of the connection portion 61, and a threaded channel matching the double thread is disposed in the bushing 2. The fixing base 6 of the massage head may be screwed into the bushing 2 by means of one threaded head or the other. The conductive wire 11 may be in contact with the conductive elastic piece 3 only by screwing the fixing base 6 of the massage head into the bottom of the bushing 2, to establish an electrical connection. The through-hole 21 is provided at the bottom of the bushing 2. In addition, the limit groove 22 is further provided at the bottom of the bushing 2, and the limit groove 22 is connected to the through-hole 21. A plurality of conductive wires 11 protrude from the edge of the fixed seat 1, one ends of the conductive wires 11 pass through the fixed seat 1, and ports of the conductive wires 11 are uniformly distributed on the fixed seat 1. Referring to FIG. 5, six conductive wires 11 (A, B, C, D, E, and F shown in FIG. 5) are uniformly distributed on the fixed seat, three conductive elastic pieces 3 are uniformly distributed on the bushing 2 in a triangular shape, a first external thread and a second external thread are provided on the fixing base 6 of the massage head, and a first internal thread and a second internal thread are provided on the bushing 2. When the first external thread is embedded in the first internal thread and screwed in place, and the second external thread is embedded in the second internal thread and screwed in place, three conductive wires 11 (A, C, and E) are in contact with the conductive elastic piece 3. When the first external thread is embedded in the second internal thread and screwed in place, and the second external thread is embedded in the first internal thread and screwed into place, three conductive wires 11 (B, D, and F) are in contact with the conductive elastic piece 3.

The conductive elastic piece 3 is bent, and has one side tightly abutting against the conductive wires 11 and an inner wall of the bushing 2. The conductive elastic piece 3 is squeezed by the conductive wires 11 and the bushing 2, ensuring good electrical contact. The other surface of the conductive elastic piece 3 passes through the through-hole 21 and extends into the limit groove 22. This plays a limiting role, and enhances the fixing effect of the conductive elastic piece 3. In a vibration environment in which a massage gun works, the massage gun moves vertically up and down, and the conductive wire 11 transversely squeezes the conductive elastic piece 3. Therefore, this structure can effectively prevent the conductive elastic piece 3 from being not in contact with the conductive wire 11, ensuring the stable transmission of a current.

As a connection component between the fixing base of the massage head and the slide bar 4, the bushing 2 is fixed inside the slide bar 4, and provides necessary guiding and limiting functions for the mounting of the massage head. The whole energizing structure implements stable electrical contact in a complex vibration environment by means of fitting of components, and provides reliable power supply for the massage gun. This ensures the normal work of the cold and hot massage head.

Referring to FIG. 1 to FIG. 6, in another embodiment, the bushing 2 is connected to the slide bar 4 via glue.

In this embodiment, the bushing 2 is tightly fitted with the slide bar 4, to avoid loosening and disconnection, thereby ensuring the stability of transmission of the current.

Referring to FIG. 1 to FIG. 6, in another embodiment, a wire passing hole 41 is provided on the slide bar 4, and the wire passing hole 41 is opposite to the through-hole 21.

In this embodiment, cables are managed easily. Therefore, the cables may pass in a neat and orderly manner. This resolves a problem that the cables are disorganized, and improves the aesthetics. The occupation of space by the cables is reduced. Therefore, the layout of the energizing structure for a cold and hot massage head of a massage gun is more compact, and the utilization of the space is improved.

Referring to FIG. 1 to FIG. 6, in another embodiment, a placement groove 23 is further provided at a middle part of the bottom of the bushing 2, an edge of the placement groove 23 extends outwardly to form a connection groove 24, and the connection groove 24 is connected to the limit groove 22.

In this embodiment, the placement groove 23 is provided at the middle part of the bottom of the bushing 2, and used to accommodate and arrange the redundant cables. The edge of the placement groove 23 extends outwardly to form the connection groove 24. This provides extra coiling space for the cables, and ensures that the cables are managed in an orderly manner. The connection groove 24 is connected to the limit groove 22 on the bushing 2. By means of this connection structure, after the cables pass through the wire passing holes 41, the redundant cables are coiled and fixed in the placement groove 23. In addition, the cables are stable and do not fall off by means of interaction between the connection groove 24 and the limit groove 22. Therefore, the cables are effectively managed and the space is rationally utilized.

Referring to FIG. 1 to FIG. 6, in another embodiment, a retention groove 12 is provided on the fixed seat 1, a PCB 5 is disposed in the retention groove 12, and the PCB 5 is electrically connected to the conductive wire 11. A wiring terminal 51 is fixedly disposed on the PCB 5.

In this embodiment, the retention groove 12 is provided on the fixed seat 1, and used to position and mount the PCB 5. The PCB 5 is mounted in the retention groove 12 and establishes an electrical connection with the conductive wire 11. This ensures the transmission of signals and the flow of the current. The wiring terminal 51 is fixedly disposed on the PCB 5. The main purpose of this design is to fix a connection wire of the massage head via the wiring terminal 51 when the massage head is connected to the PCB 5, to ensure solidity and reliability of the connection wire. The wiring terminal 51 provides a fixing point for the connection wire, and ensures the effective transmission of the signals and the current between the massage head and the PCB 5.

Referring to FIG. 1 to FIG. 6, in another embodiment, the energizing structure for a cold and hot massage head of a massage gun further includes the fixing base 6 of the massage head. The connection portion 61 protrudes from the fixing base of the massage head 6, a thread is provided on the side surface of the connection portion 61 and matches the thread on the inner wall of the bushing 2, and the end surface of the connection portion 61 is locked with the fixed seat 1 in a threaded manner.

In this embodiment, the end surface of the connection portion 61 is locked with the fixed seat 1 in a threaded manner.

In an assembly process, the end surface of the connection portion 61 is locked with the fixed seat 1 via a threaded nail, to clamp the conductive wire 11 and prevent the conductive wire 11 from falling off.

Referring to FIG. 1 to FIG. 6, in another embodiment, a silicone washer 7 is sleeved on the fixing base 6 of the massage head.

In this embodiment, sealing is enhanced, to prevent external substances such as moisture and dust from entering the energizing structure for a cold and hot massage head of a massage gun, and improve waterproof and dustproof performance of the energizing structure for a cold and hot massage head of a massage gun. Cushioning effect is provided, to reduce friction and vibration between the massage head and the fixing base, and prolong the service life.

The above embodiments are only preferred ones of the present disclosure, and are not intended to limit the present disclosure in any form. Although the present disclosure has been disclosed by the foregoing embodiments, these embodiments are not intended to limit the present disclosure. Any person skilled in the art may make some changes or modifications to implement equivalent embodiments with equivalent changes by using the technical contents disclosed above without departing from the scope of the technical solution of the present disclosure. Any simple modification, equivalent change and modification made to the foregoing embodiments according to the technical essence of the present disclosure without departing from the content of the technical solution of the present disclosure shall fall within the scope of the technical solution of the present disclosure.

What is claimed is:

1. An energizing structure for a cold and hot massage head of a massage gun, comprising a fixed seat, a bushing, a conductive elastic piece, a slide bar, and a fixing base of a massage head, wherein a connection portion protrudes from the fixing base of the massage head, the connection portion is embedded in the bushing, the fixed seat is fixedly disposed on the connection portion, a through-hole is provided at a bottom of the bushing, a limit groove is further provided at the bottom of the bushing, the limit groove is connected to the through-hole, a conductive wire protrudes from an edge of the fixed seat, the conductive elastic piece is bent, the conductive elastic piece has one side abutting against the conductive wire and an inner wall of the bushing and the other bent side passing through the through-hole and disposed in the limit groove, and the bushing is fixedly disposed in the slide bar.

2. The energizing structure for a cold and hot massage head of a massage gun according to claim 1, wherein the bushing is connected to the slide bar via glue.

3. The energizing structure for a cold and hot massage head of a massage gun according to claim 2, wherein a wire passing hole is provided on the slide bar, and the wire passing hole is opposite to the through-hole.

4. The energizing structure for a cold and hot massage head of a massage gun according to claim 3, wherein a placement groove is further provided at a middle part of the bottom of the bushing, an edge of the placement groove extends outwardly to form a connection groove, and the connection groove is connected to the limit groove.

5. The energizing structure for a cold and hot massage head of a massage gun according to claim 1, wherein a retention groove is provided on the fixed seat, a printed circuit board (PCB) is disposed in the retention groove, and the PCB is electrically connected to the conductive wire.

6. The energizing structure for a cold and hot massage head of a massage gun according to claim 5, wherein a wiring terminal is fixedly disposed on the PCB.

7. The energizing structure for a cold and hot massage head of a massage gun according to claim 1, wherein an end surface of the connection portion is locked with the fixed seat in a threaded manner.

8. The energizing structure for a cold and hot massage head of a massage gun according to claim 7, wherein a silicone washer is sleeved on the fixing base of the massage head.
